(19) United States
(12) Patent Application Publication
(10) Pub. No.: US 2008/0295701 A1
(43) Pub. Date: Dec. 4, 2008

(54) POPCORN POPPER

(75) Inventor: Norbert Richter, Elmenhorst (DE)

Correspondence Address: LEMPIA BRAIDWOOD LLC, 223 W. JACKSON BLVD., SUITE 620, CHICAGO, IL, 60606, US

(73) Assignee: PCO Group GmbH, Dassow (DE)

(21) Appl. No.: 12/128,244

(22) Filed: May 28, 2008

(30) Foreign Application Priority Data
May 29, 2007 (DE) 10 2007 025 026.8

(51) Int. Cl. H05B 6/12; A23L 1/18

(52) U.S. Cl. 99/323.5; 99/323.9; 219/621

(57) ABSTRACT

The disclosed popcorn popper has a housing and a container for heating popcorn popping ingredients introduced into the container for popcorn making. The container can be pivoted with respect to the housing for emptying. The popcorn popper also has an induction heater with an induction coil disposed beneath the container for generating a alternating high-frequency magnetic field. The induction coil is pivotable together with the container.

### RELATED APPLICATION DATA

This patent is related to and claims priority benefit of German patent application no. 10 2007 025 026.8, filed on May 29, 2007, which is incorporated herein by reference in its entirety.

### BACKGROUND OF THE INVENTION

1. Field of the Disclosure

The invention relates to a popcorn popper having a housing, a container for making popcorn by heating corn and fat introduced into the container, wherein the container can be pivoted with respect to the housing for emptying, and an induction heater having an induction coil arranged beneath the container for generating a high-frequency alternating magnetic field.

2. Description of Related Art

Popcorn poppers normally have a housing and a pot- or kettle-type container, which can be pivoted with respect to the housing and which is used to heat corn, fat and eventually further ingredients for popcorn making. To this end mostly a bent tubular heating element of a resistance heater is mounted beneath the bottom wall of the container. The heating element can be supplied with power from the main source for heating the bottom wall of the container and therefore the ingredients for popcorn making having been previously introduced into the container, and for keeping them at the temperature necessary for popcorn making. In addition, popcorn poppers have an agitator for agitating the contents of the container during heating in order to provide for a more homogenous warming up of the corn kernels until the popping takes place. As the volume of the corn kernels increases dramatically during the popping while their specific weight decreases dramatically, the corn kernels having not yet popped will remain at the bottom of the container while the finished popcorn will be transported upwardly by the action of the agitator. When the container is full, the popcorn will urge the container lid open, which until then has prevented the corn kernels from being thrown out of the container, and will then fall down into a collecting bowl normally arranged in a warming space of the housing. In smaller popcorn poppers the container is pivotably suspended from an upper or roof part of the housing whereas in larger poppers it is pivotably mounted on a pedestal above the collecting bowl. Due to this, the container can be pivoted into an emptying position after the popcorn has been finished, in which position the remaining popcorn will fall from the container into the collecting bowl from where it can be collected at will. After the container has been pivoted back in its working position, it is ready for receiving a new load of fat and corn.

The production of popcorn in a container which is heated with a resistance heater will consume a lot of energy. On one hand, the container must have a relatively large heat capacity and therefore will dissipate a lot of radiation heat into the surroundings, which therefore will not be available for heating the ingredients. Furthermore, the container must remain heated in the time after it has been emptied and before it will be filled again, in order to prevent an undesirable cooling down of the container before the introduction of the next load. This will also lead to a loss of much energy.

Due to this reason, U.S. Pat. No. 5,928,550 proposed a popcorn popper of the type mentioned above and which has an induction heater instead of a resistance heater. The induction heater of this popcorn popper comprises a generator and an induction coil for generating an alternating high-frequency magnetic field. The generator and the induction coil are arranged beneath the pivotable container in a stationary shell, which stands up from the collecting bowl and protrudes into the warming space. However, this arrangement has several drawbacks. On one hand, the shell occupies quite a lot of space in the warming space, which is actually intended for containing popcorn. On the other hand, withdrawal of popcorn from the warming space and the collecting bowl is made more difficult, and in particular, withdrawal of popcorn which has dropped between the circular shell and the rear wall of the housing.

In order to enable pivoting of the container suspended from the roof of the warming space from its working position, where the opening of the container faces upwardly, by more than 90 degrees into an emptying position, where the opening of the container faces downwardly, there must also be a large distance between the top of the shell and the bottom wall of the container. This however results in a considerable weakening of the alternating magnetic field produced by the induction coil before it reaches the container bottom wall to be heated. A large amount of time and electrical power will thus be needed for heating of the container bottom wall. In addition, during emptying of the container popcorn will fall on top of the shell from where it will have to be carefully removed because it can otherwise be burned from the heat radiating downwardly from the container bottom wall once the container is back in the working position and the induction coil is energized. The container of U.S. Pat. No. 5,928,550 does not house any electrical components in order to be able to submerge it in water during cleaning. However, this will make it quite difficult to precisely measure the temperature of the container bottom wall and to keep it in a narrow temperature range desired for popcorn making.

### SUMMARY

In view of the forgoing, it is an aim of the disclosed popcorn popper to avoid a weakening of the alternating magnetic field generated by the induction coil due to an excessively large distance between the induction coil and the bottom wall of the container in a popcorn popper of the prior art.

It is another aim of the disclosed popcorn popper to decrease the time needed for the production of one load of popcorn.

In addition, it is a further aim of the disclosed popcorn popper to use as much space as possible in the warming space for popcorn storage and to facilitate the withdrawal of popcorn from the collecting bowl.

Furthermore, it is another aim of the disclosed popcorn popper to positively prevent an overheating of popcorn inside or outside the container.

According to the invention, these aims are accomplished by a popcorn popper wherein the induction coil is pivotable together with the container and preferably is integrated into the bottom of the container.

Tests conducted with a popcorn popper according to the invention have demonstrated that, in comparison with a conventional popcorn popper having a resistance heater, a load of corn with the same quantity can be popped with 30 to 35% less energy, and the time needed for the popping being 30 to 50% shorter.

It is already known from popcorn poppers with a resistance heater to accommodate the heating elements of the resistance heater in a double walled bottom of the container. However, these heating elements are made of a metal with a high electric resistance, e.g. nickel, in order to provide for fast heating of the heating elements when they are energized, whereas the leads leading from the main power source or a power adapter to the heating elements are made from copper or another material with a very low electric resistance, so that they will only heat up to a very small degree when the heating elements are energized, and therefore the heating is restricted to the heating elements themselves. In contrast to resistance heaters, induction heaters comprise a high-frequency generator or frequency transformer, which should be positioned a distance from the induction coil due to the influence of the alternating magnetic field of the induction coil onto the components of the high-frequency generator or frequency transformer. Therefore, the latter cannot be integrated into the container of a popcorn popper without considerably increasing the volume of the container.

However, if the high-frequency generator or frequency transformer is stationary in the housing of the popcorn popper and is connected by leads with the induction coil, an alternating magnetic field will be generated around each of the leads when the induction coil is energized. These alternating magnetic fields will pose some problems as they can lead to eddy currents in adjacent metallic parts of the housing, which will result in an unwanted heating of these parts as well as safety problems.

However the inventor of the disclosed popcorn popper has found out that theses problems can be avoided if according to a preferred embodiment of the invention the stationary high-frequency generator or frequency transformer in the housing of the popcorn popper is connected to the induction coil by two leads extending in close proximity. In such case, the high-frequency alternating magnetic fields generated around the two leads will essentially cancel out each other.

According to a further preferred embodiment of the invention, the induction coil is disposed in a space between inner and outer bottom walls of the container. The inner bottom wall, which is disposed above the induction coil, is made of an electrically conductive metal, wherein eddy currents will be generated by the alternating high-frequency magnetic field of the induction coil when the latter is energized with a high-frequency alternating current. Most preferably the inner bottom wall is made of a ferromagnetic metal with a high magnetic permeability. The lines of force of the magnetic field will then be concentrated in the inner bottom wall where strong eddy currents will be induced. Due to the relatively high electric resistivity of ferromagnetic metals, the eddy currents will lead to a very fast heating of the bottom wall. Furthermore, in ferromagnetic materials additional heat will be produced by an asynchronous pole inversion of Weiss' domains.

In order to avoid an excessive heating of the induction coil due to the heat radiated downwardly by the inner bottom wall, preferably the induction coil will be positioned a distance from 10 mm to 30 mm beneath the inner bottom wall, the outer diameter of the induction coil being conveniently the same as the diameter of the inner bottom wall.

Advantageously, the induction coil consists of at least one spirally wound conductor, which is mounted on a heat resistant flat support in parallel orientation to the inner bottom wall. In order to avoid that the alternating magnetic field will extend downwardly beyond the support, preferably flux conducting pieces with a high magnetic permeability are attached to the lower surface of the support. In contrast to the inner bottom wall, however, the flux conducting pieces are made from a electrically isolating material and conveniently from ferrite in order to counteract an induction of eddy currents.

The outer bottom wall of the container, which primarily serves as a shield to prevent touching of the induction coil and the leads, will be conveniently arranged a small distance beneath the induction coil and advantageously is made of an electric isolator with diamagnetic or paramagnetic characteristics. Preferably a heat-resistant plastic or ceramic material is used for the outer bottom wall that will resist heat radiated downwardly from the inner bottom wall and will not heat up in the weak stray magnetic field generated below the induction coil.

In order to avoid an overheating of corn, fat and popcorn in the container due to an overheated inner bottom wall of the container the popcorn popper, according to a further preferred embodiment of the invention, has a temperature sensor for measuring the temperature of the inner bottom wall. The temperature sensor is conveniently in contact with the inner bottom wall and being disposed in the space between the inner and outer bottom walls.

Furthermore, the popcorn popper preferably comprises a means for controlling or regulating the power supply to the induction coil and/or the frequency of the electric current supplied to the induction coil dependent on the temperature of the inner bottom wall in order to keep the latter within an optimum temperature range.

As a measure to avoid an excessive heating of the induction coil and the outer bottom wall, the outer bottom wall and/or a peripheral wall between the outer and inner bottom walls can be provided with vent openings. A forced ventilation of the space between the outer and inner bottom walls can also be provided by means of an electrically powered ventilator.

In order to avoid that the heating of the inner bottom wall is continued, even though there is no more popcorn in the container after the latter has been emptied, preferably the popcorn popper comprises a means for automatically switching off the power supply to the induction coil as soon as the container is pivoted from its horizontal working position into a slanted emptying position or as soon as a locking device of the container is released or unlocked before pivoting the container into the emptying position. After these means have been activated, a switch can conveniently be operated manually before a power supply to the induction coil is possible again.

In smaller popcorn poppers where the container is suspended above the collecting bowl in the warming space, the agitator will normally project into the container from above and will be driven by a drive shaft of an electric drive motor mounted in the upper part of the housing above the container. In contrast, in larger popcorn poppers with a container mounted on a pedestal above the collecting bowl, the agitator will be driven by a drive motor via a drive shaft extending through the bottom wall into the interior of the container. In this case, the induction coil conveniently will have a central opening for the drive shaft. In order to avoid heating of the drive shaft by the alternating magnetic field in this region and also between the induction coil and the bottom wall of the container, at least a portion of the drive shaft can be made of an electrically insulating diamagnetic or paramagnetic material or can alternatively be surrounded by a sheath of an electrically isolating ferromagnetic material, like ferrite.

### BRIEF DESCRIPTION OF THE DRAWINGS

The disclosed popcorn popper will be explained with reference to two embodiments illustrated in the following drawing:

FIG. 1 is a perspective view of a smaller popcorn popper with an induction heater;

FIG. 2 is an exploded perspective view of a heatable container of the popcorn popper of FIG. 1 for popcorn making;

FIG. 3 is an enlarged bottom view of the induction coil; and

FIG. 4 is a cross sectional view of parts of a larger popcorn popper with an induction heater.

### DETAILED DESCRIPTION OF THE DISCLOSURE

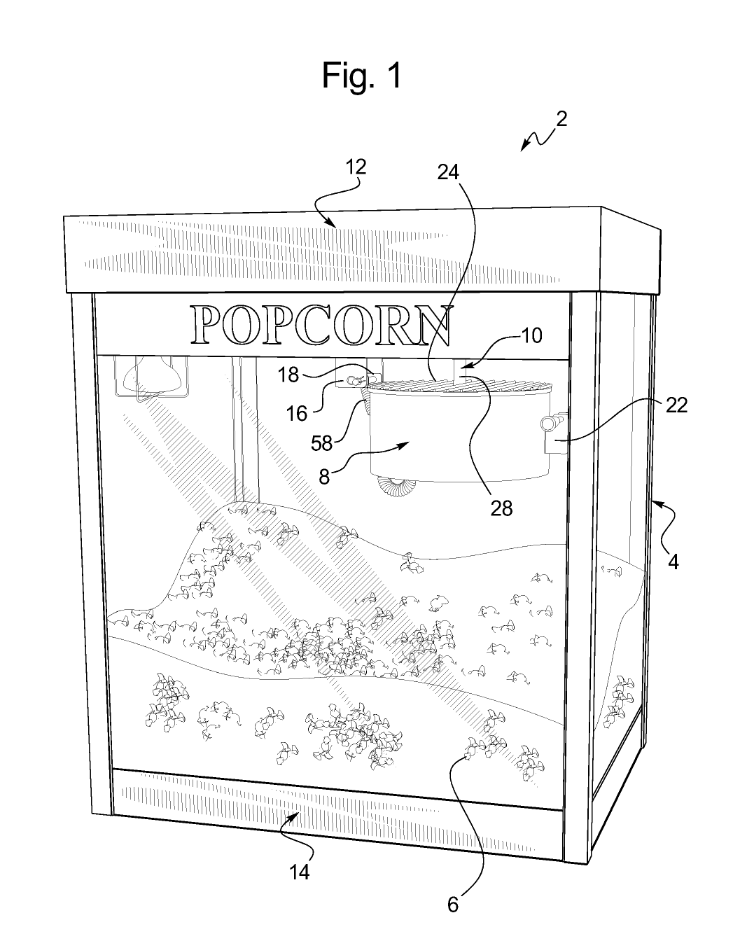

Like most machines for making popcorn from corn kernels, fat and eventually any further ingredients, the popcorn popper 2 illustrated in FIG. 1 comprises a housing 4 and a lighted and heatable warming space 6 enclosed by the housing. A collecting bowl (not visible) forms the bottom wall of the warming space 6 for receiving the finished popcorn. The popcorn popper also has a heatable kettle 8 accommodated inside the warming space 6. The corn kernels, the fat and any further ingredients can be heated in the kettle 8 until the corn kernels are popping. The popcorn popper further has a power driven agitator 10 for stirring the ingredients in the kettle 8.

The housing 4 basically consists of four side walls surrounding the sides of the warming space 6 and being made partially or wholly of glass. At least one of the side walls can be opened for taking out popcorn from the warming space 6 or the collecting bowl respectively. A housing upper part 12 is disposed above the warming space 6 and forms the roof of the warming space 6. A housing bottom part 14 is disposed beneath the warming space 6 or the collecting bowl respectively.

In the smaller popcorn popper 2 illustrated in FIG. 1, the heatable pot-shaped kettle 8 is pivotably suspended in the upper part of the warming space 6. One side of the kettle 8 is articulated to a bracket 16 of the housing upper part 12 by means of an articulating joint 18 having a horizontal pivot axle 20. The other side of the kettle 8 is connected to a further bracket (not visible) of the housing upper part 12 by means of a releasable locking mechanism 22. When the locking mechanism 22 is locked, the kettle 8 is held in a horizontal working position illustrated in FIG. 1. In the working position, an opening of the kettle 8 faces upwardly and is closed by a lid 24. After finishing one load of popcorn in the kettle 8, the locking mechanism 22 can be unlocked or released by means of an unlocking lever 26 and the kettle 8 can be turned around via the pivot axle 20 into an emptying position. In the emptying position, the opening of the kettle 8 is slanted downwardly so that the popcorn in the kettle 8 can fall in the collecting bowl of the warming space 6. The lid 24 of the kettle 8 is provided with an opening in its center for a drive shaft 28 of the agitator 10. The upper end of the drive shaft 28 is coupled to a drive motor (not visible) in the housing upper part 12 while the lower end of the drive shaft is equipped with agitator fingers or blades (not visible).

In the horizontal working position the agitator fingers or blades project from above into the interior of the kettle 8 so that the corn kernels in the kettle 8 can be agitated while they are heated in order to provide for a uniform heating. The lid 24 rests loosely on an upper rim of the kettle 8 so that it can be raised by the popcorn in the kettle 8 once the volume of the contents of the kettle 8 exceeds the volume of the kettle 8 after the popping of the corn kernels. When the kettle 8 is turned or pivoted into the slanted emptying position, the lid 24 will be retained by the drive shaft 28 so that the remaining popcorn can fall through the opening out of the kettle 8.

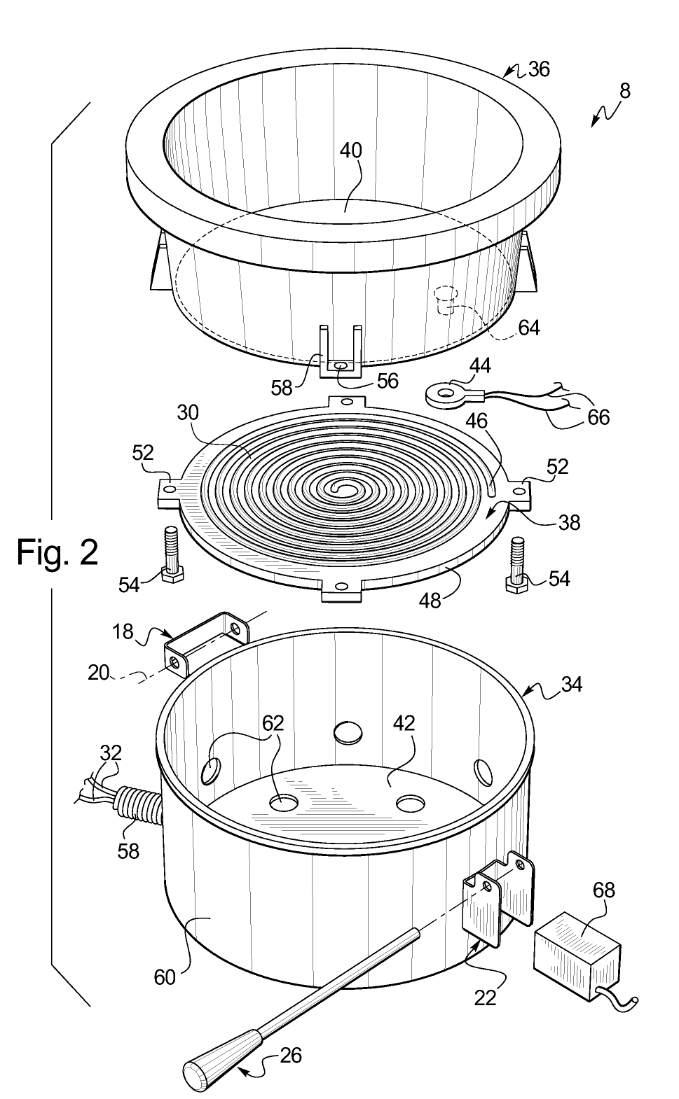

For heating of the kettle 8, the popcorn popper 2 has an induction heater that has a stationary frequency transformer (not visible) accommodated or positioned in the housing upper part 12 and an induction coil 30 (FIG. 2) integrated in the kettle 8, which is connected to the frequency transformer by leads 32.

As best shown in FIG. 2, the kettle 8 has a deeper pot-shaped outer kettle 34, a pot-shaped inner kettle 36 of somewhat lesser depth, and the flat induction coil 30. The coil 30 is mounted on a support 38 and is disposed in a space between a lower circular bottom wall 42 of the outer kettle 34 and an upper circular bottom wall 40 of the inner kettle 36. The support 38 is parallel to the bottom walls 40 and 42. Furthermore, beneath the bottom wall 40 of the inner kettle 36, a temperature sensor 44 is located for measuring the temperature of the bottom wall 40.

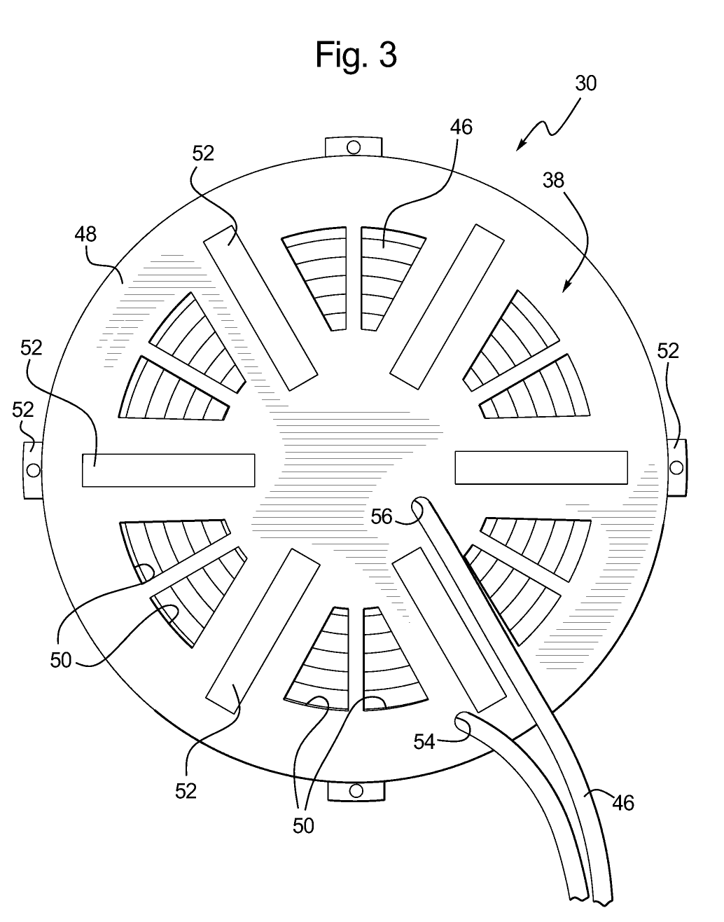

The induction coil 30 comprises a spirally wound conductor 46 made from twisted copper wires. The conductor is positioned in a winding plane on the upper surface of the support 38 and is covered with a heat-resistant isolating resin. As can be best seen in FIGS. 2 and 3, the support 38 has a flat disc 48 made from a heat-resistant plastic material and is provided with several through openings for better cooling of the spiral-shaped conductor 46. For its assembly with the inner kettle 36, the disc 48 is provided with four radially protruding fixation lugs 52 each having a borehole. The boreholes will receive set screws, which can be threaded through the boreholes into threaded bores 56 in projections 58 of the inner kettle 36 in order to mount the induction coil 30 a desired distance from the bottom wall 40 of the inner kettle 36.

A plurality of radially oriented elongated flux conducting pieces 52 made from an electrically isolating ferrite material with a high magnetic permeability are arranged on the bottom surface of the disc 48 between the through openings 50. The pieces 52 will concentrate the force lines of the magnetic field beneath the support 38 between its outer periphery and its center and will prevent the magnetic field from extending beyond the bottom surface of the disc 48.

From the outer and inner ends of the induction coil 30 close to the periphery and the center of the support 38, respectively, the conductor 46 extends through boreholes 54, 56 of the support 38 into a space between the support 38 and the bottom wall 42 of the outer kettle 34 where the ends of the conductor are connected to the leads 32.

The leads 32 are likewise made from twisted copper wire and have the same cross sectional area as the conductor 36. The leads extend from the outer kettle 34 through a flexible hose 58 to the upper housing part 12 where their ends are connected to terminals of the frequency transformer. In order to prevent heating of the hose 58 by the alternating magnetic field generated around the leads 32, the leads 32 extend in close proximity to each other through the hose 58 so that the two alternating magnetic fields will essentially cancel each other out. In addition, the hose 58 is either made of non-conducting heat-resistant plastic material or alternatively of non-magnetic stainless steel.

The outer kettle 34 comprises a cylindrical wall portion 60. Parts of the articulating joint 18 and the locking mechanism 22 as well as the unlocking lever 26 are fastened close to the upper rim of the wall portion 60 so that the lever 26 can be grasped by a user in order to unlock and hold the kettle 8 during its pivoting movement. The bottom wall 42 fixed to the lower end of the wall portion 60 is made from a non-conducting paramagnetic or diamagnetic material, such as for example, ceramics or a heat-resistant plastic material, like polycarbonate. In the bottom wall 42 and in the lower rim of the wall portion 60 there are vent openings 62. Heat radiating downwardly from the heated bottom wall 40 of the inner kettle 36 can be dissipated via the vent openings 62 from the space between the bottom walls 40 and 42 by air circulation. In connection with measurement of the temperature of the bottom wall 40 of the inner kettle 36 by means of the temperature sensor 44 and control of the power supply to the induction coil 30 as a function of the measured temperature, overheating of the induction coil 30 and the two bottom walls 40, 42, as well as overheating of fat and corn kernels or finished popcorn in the kettle 8, respectively, can be avoided and the temperature of the bottom wall 40 can be maintained within an optimum narrow temperature range.

The inner kettle 36, and particularly the bottom wall 40 of the inner kettle 36, is made of magnetic stainless steel or another ferromagnetic metal with a high magnetic permeability. With the aid of the set screws 54, the bottom wall 40 can be disposed a desired distance of between 20 mm to 30 mm above the induction coil 30. On one hand, this distance is short enough to ensure that the bottom wall will protrude far into the alternating magnetic field generated by the induction coil 30. On the other hand, this distance is long enough to avoid overheating of the induction coil 30 by the heat radiated downwardly from the bottom wall 40 during the heating of the kettle 8. The temperature sensor 44 is a contact sensor formed as an eyelet and is fastened by means of a nut (not shown) to a screw 64 protruding beyond the lower surface of the bottom wall 40.

The lower housing part 14 of the popcorn popper 2 in FIG. 2 can comprise one or more heating elements (not shown) of a resistance heater serving to heat the warming space 6. The housing upper part 12 encloses, besides the drive motor for the agitator 10, a main power source adapter (not shown) connectable to the main power source, the frequency transformer for transforming the frequency of the alternating current from the mains into a frequency of about 50 to 60 kHz, and a control unit (not visible) for controlling the induction heater by switching on and off the power supply to the induction coil 30.

The control unit will supply the induction coil 30 with power from the frequency transformer after the popcorn popper 2 has been manually switched on by actuation of a switch on an operating panel disposed at the rear of the housing upper part 12 after a load of corn kernels and fat has been filled into the inner kettle 36. After the switch is actuated, the frequency transformer will generate an alternating current with a frequency of 50 kHz to 60 kHz whereby the induction coil 30 will generate a magnetic field alternating with the same frequency. The alternating magnetic field induces eddy currents in the bottom wall 40 of the inner kettle 36 whereupon the latter will heat up quite fast as it has only a relatively small wall thickness of 2 mm to 3 mm. Because beneath the induction coil there is no electrically conductive material and the magnetic force lines of the alternating magnetic field are concentrated and conducted by the magnetic flux conducting pieces 52 made of ferrite from the outer periphery of the support 38 to the center thereof, there will occur no heating up beneath the induction coil 30. However, due to heating of the upper bottom wall 40, heat will be radiated downwardly into the space between the upper and lower bottom walls 40, 42, which will then be dissipated by the air circulating through the vent openings 62.

When the temperature of the bottom wall 40 rises above a predetermined upper temperature limit of more than 250° C., or preferably of more than 210° C. to 220° C., this temperature increase will be detected by the temperature sensor 44 and transmitted to the control unit. Then the control unit will switch off the power supply to the induction coil 30 for a short period of time. When the temperature of the bottom wall 40 has fallen again below a lower temperature limit of less than 150° C., or preferably less than 180° C. to 190° C., the control unit will switch on the power supply to the induction coil 30 again. In this temperature range of the bottom wall 40, there will occur an optimum popping of the corn kernels in the kettle 8 because the corn kernels will then be heated neither too fast nor too slow. The temperature sensor 44 is connected to the control unit by signal lines 66 extending through the hose 58 together with the leads 32.

As also best illustrated in FIG. 2, in the vicinity of the part of the locking mechanism 22 mounted to the wall portion 60 of the outer kettle 34, a switch 68 is mounted to the bracket of the housing upper part 12. The switch 68 may be, for example, in the form of a contact switch, a solenoid switch or a proximity switch. The switch 68 will interrupt the power supply to the induction coil 30 when the unlocking lever 26 is actuated by a user to unlock the locking mechanism 22 in order to be able to turn the kettle 8. This will ensure that the induction coil 30 will be energized only when the kettle 8 is in its working position illustrated in FIG. 1. The switch 68 is connected to the control unit in such a way that the induction coil 30 can be energized again only after a switch on the operating panel has been manually operated.

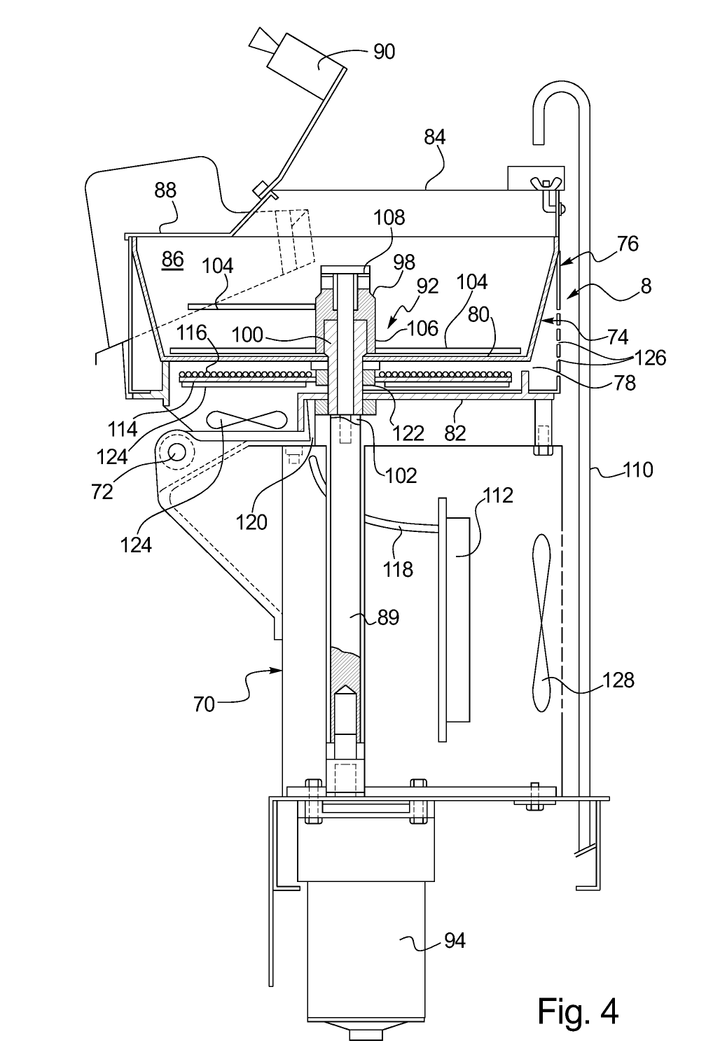

In larger popcorn poppers 2, the kettle 8 is not suspended from the upper housing part 12 like in the popcorn popper 2 described before. As illustrated in FIG. 4, the kettle 8 is instead mounted on a supporting pedestal 70 protruding upwardly beyond a collecting bowl (in FIG. 4 not illustrated) of the housing 4 of the popcorn popper 2. The kettle 8 can be turned around a horizontal pivot axle disposed beneath the kettle 8 and laterally of the supporting pedestal 70. The kettle 8 also has an outer kettle 74 and an inner kettle 76, which are separated by a space 78. Like the inner kettle 36 in FIG. 2, the inner kettle 76 has a thin bottom wall 80 made of ferromagnetic metal with a high magnetic permeability, while the bottom wall 82 of the outer kettle 74 is made of a heat-resistant non-conducting diamagnetic or paramagnetic material.

On the top the kettle 8 is closed by a fixed lid 84. One side the kettle 8 has a dispensing channel 86 situated somewhat below the lid 84 and closed by a pivotable flap 88. The flap 88 is maintained in its closed position by counterweights 90 until the pressure of the finished popcorn in the kettle 8 forces it upwardly into an open position as soon as the kettle 8 is completely filled with popcorn. A part of the popcorn can then be dispensed through the dispensing channel 86 into the collecting bowl, which can be disposed in a warming space like the space 6 in the popcorn popper of FIG. 1.

The agitator 92 of the kettle 8 illustrated in FIG. 3 has a drive motor 94 disposed beneath the kettle 8 inside the supporting pedestal 70 and a two part drive shaft. The vertical lower part 96 of the drive shaft is journalled in the supporting pedestal 70 while the upper part 98 of the drive shaft is journalled in a bearing sleeve 100 extending through the bottom walls 80, 82 of the kettle 8 and can be pivoted together with the kettle 8. The two parts 96, 98 are coupled at 102 by means of a coupling which will be automatically brought in and out of engagement when the kettle 8 is pivoted. The agitator 92 comprises a plurality of agitator fingers or blades 104, which, in the vicinity of the bottom wall 80 and in a larger distance from the bottom wall 80, respectively, project radially outwardly from a rotatable cover cap 106. The cover cap 106 is attached to the upper part 98 of the drive shaft by means of a pin 108 and surrounds the bearing sleeve 100, which is projecting into the kettle 8.

Here, the fat needed for popcorn making is supplied in liquid form through an oil delivery tube 110 into the kettle 8.

The induction heater has a frequency transformer 112 connected to a main power source adapter (not illustrated) and is accommodated or positioned inside the supporting pedestal 70. The heater also has an induction coil 116 disposed on a support 114 in the space 78 between the bottom walls 80, 82 of the inner and outer kettles 74, 76 and is pivotable together with the kettle 8. Like the popcorn popper 2 of FIGS. 1 and 2, the frequency transformer 102 is connected to the induction coil 116 by leads 118, which, after their exit from the supporting pedestal 70, extend through a flexible hose 120 to the outside of the outer kettle 78 and from there into the space 78.

The induction coil 116 and the support 114 essentially have the same configuration as the ones shown in FIG. 2, except that the support 114 and the induction coil 116 surround a central opening. In the opening, a retaining ring 122 is fastened to the support 114. The retaining ring 122 is slid onto the bearing sleeve 100 a distance below the bottom wall 80 of the inner kettle 74 and is fixedly connected to the bearing sleeve 100 so that the rotatable upper part 98 of the drive shaft will axially extend through the opening of the support 114 and the induction coil 116. Like the flux conducting pieces 124 on the bottom surface of the support 114, the retaining ring 122 can be made from a ferrite material in order to avoid that the force lines of the alternating magnetic field extend to the bearing sleeve 100 and the drive shaft to prevent heating of the bearing sleeve 100 and the upper part 98 of the drive shaft. Alternatively, the bearing sleeve 100 and the upper part 98 of the drive shaft can be made of a non-conducting diamagnetic or paramagnetic material, for example a plastic material, so that they do not heat up in the alternating magnetic field extending through the opening.

In order to avoid an undue heating of the support 114 and the induction coil 116 by heat radiated downwardly from the bottom wall 80, a ventilator 124 is disposed in the space 78. The ventilator 124 will draw in air from below through an opening into the space 78 and blow it against the bottom surface of the support 114. From there the air will flow along the bottom surface of the support 114 to vent openings 126 on the opposite side of the outer kettle 76. For cooling of the frequency transformer 112, there is a further ventilator 128 in the supporting pedestal 70.

Like with the kettle 8 in FIG. 2, the temperature of the bottom wall 80 will be measured by a temperature sensor (not shown) and the power supply to the induction coil 116 will be controlled as a function of the measured temperature. When the kettle 8 is turned over, the power supply will be interrupted as well.

Although certain popcorn popper examples have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A popcorn popper comprising:
a housing;
a container for heating ingredients introduced into the container for popcorn making, wherein the container is pivotable with respect to the housing for emptying; and
an induction heater having an induction coil disposed beneath the container for generating an alternating high-frequency magnetic field, wherein the induction coil is pivotable together with the container.

2. A popcorn popper according to claim 1, wherein the induction heater comprises a high-frequency generator or frequency transformer that is positioned stationary in the housing of the popcorn popper.

3. A popcorn popper according to claim 2, wherein the high-frequency generator or frequency transformer is connected to the induction coil by two leads extending in close proximity to each other.

4. A popcorn popper according to claim 3, wherein the leads extend in close proximity to each other either between the container and the housing or inside the housing.

5. A popcorn popper according to claim 4, wherein between the container and the housing the leads extend through a hose made of a diamagnetic material or a paramagnetic material.

6. A popcorn popper according to claim 1, wherein the induction coil is disposed in a space between inner and outer bottom walls of the container.

7. A popcorn popper according to claim 1, wherein the induction coil is disposed a distance of 10 mm to 30 mm beneath an inner bottom wall of the container.

8. A popcorn popper according to claim 1, wherein the induction coil is disposed on a flat disc-shaped support.

9. A popcorn popper according to claim 8, further comprising radial flux conducting pieces on a bottom surface of the support.

10. A popcorn popper according to claim 1, further comprising a temperature sensor for measuring the temperature of an inner bottom wall of the container.

11. A popcorn popper according to claim 10, wherein the temperature sensor is in contact with the inner bottom wall.

12. A popcorn popper according to claim 1, further comprising means for controlling a power supply to the induction coil or for controlling the frequency of the current supplied to the induction coil dependent upon the temperature of an inner bottom wall of the container.

13. A popcorn popper according to claim 1, wherein an inner bottom wall of the container is made of a ferromagnetic metal.

14. A popcorn popper according to claim 1, wherein an outer bottom wall of the container is made of a non-conducting heat-resistant material.

15. A popcorn popper according to claim 6, wherein the outer bottom wall of the container is provided with vent openings.

16. A popcorn popper according to claim 6, further comprising a means for forced ventilation of the space between the inner and outer bottom walls.

17. A popcorn popper according to claim 1, further comprising a means for interrupting a power supply to the induction coil as soon as the container is pivoted from a horizontal working position to a slanted emptying position.

18. A popcorn popper according to claim 17, further comprising a switch to be operated after an activation of the means for interrupting and before a power supply to the induction coil is possible again.

19. A popcorn popper according to claim 1, further comprising an agitator having a drive shaft which extends into the container from below and which extends through a central opening of the induction coil.

20. A popcorn popper according to claim 19, wherein at least in the region of the induction coil the drive shaft is made of a non-conducting diamagnetic material or a paramagnetic material.

21. A popcorn popper according to claim 19, wherein at least in the region of the induction coil the drive shaft is surrounded by a sleeve made of a non-conducting ferromagnetic material.

22. A popcorn popper according to claim 3, wherein the leads extend in close proximity to each other both between the container and the housing and inside the housing.

23. A popcorn popper according to claim 1, wherein an outer wall of the container is provided with vent openings.
